(19) United States
(12) Patent Application Publication
(10) Pub. No.: US 2025/0220689 A1
(43) Pub. Date: Jul. 3, 2025

(54) SIDELINK COMMUNICATION TECHNIQUE

(71) Applicant: Telefonaktiebolaget LM Ericsson (publ), Stockholm (SE)

(72) Inventors: Nithin SRINIVASAN, Köln (DE); Shehzad Ali ASHRAF, Aachen (DE); Jose Angel LEON CALVO, Aachen (DE); Zhang ZHANG, Beijing (CN); Min WANG, Luleå (SE)

(21) Appl. No.: 18/852,551

(22) PCT Filed: Mar. 31, 2023
(86) PCT No.: PCT/EP2023/058497

§ 371 Date: Sep. 30, 2024

(30) Foreign Application Priority Data
Mar. 31, 2022 (WO) PCT/CN2022/084255

(51) Int. Cl. H04W 72/25; H04W 72/0453; H04W 72/543; H04W 72/563

(52) U.S. Cl. CPC H04W 72/25; H04W 72/0453; H04W 72/543; H04W 72/563

(57) ABSTRACT

A technique for transmitting and receiving data is described. As to a method aspect performed by a transmitting radio device for transmitting data to a receiving radio device, at least one of a radio access capability message indicative of a set of frequency resources supported by the receiving radio device and a configuration message indicative of a set of frequency resources configured for transmitting to the receiving radio device is received. The data is transmitted to the receiving radio device using at least one frequency resource from a set of frequency resources configured based on at least one of the received radio access capability message and the received configuration message.

### TECHNICAL FIELD

The present disclosure relates to a technique for communicating between radio device. More specifically, and without limitation, methods and devices are provided for transmitting data from a transmitting radio device and receiving data at a receiving radio device.

### BACKGROUND

The Third Generation Partnership Project (3GPP) specified sidelinks (SLs) in Release 12 as an adaptation of the Long Term Evolution (LTE) radio access technology for direct communication between two radio devices, also referred to as user equipment (UE), without going through a base station. Such device-to-device (D2D) communications through SLs are also referred to as proximity service (ProSe) and can be used for Public Safety communications. While conventional public safety communications use different standards in different geographical regions and countries, 3GPP SL communications enable interworking of different public safety groups. 3GPP has enriched SLs in Release 13 for public safety and commercial communication use-cases and, in Release 14, for vehicle-to-everything (V2X) scenarios.

Support was again enhanced during Release 15. From the point of view of the lowest radio layers, the LTE SL uses broadcast communication. That is, transmission from a UE targets any receiver that is in range.

In Release 16, 3GPP introduced the sidelink for the 5G new radio (NR). The driving UC were vehicular communications with more stringent requirements than those typically served using the LTE SL. To meet these requirements, the NR SL is capable of broadcast, groupcast, and unicast communications. In groupcast communication, the intended receivers of a message are typically a subset of the vehicles near the transmitter, whereas in unicast communication, there is a single intended receiver.

In Release 17, 3GPP is working on enhancements for the NR SL. The ambition is not only to improve the capabilities of NR SL for V2X but also to address other UCs such as National Security and Public Safety (NSPS) as well as commercial UCs such as Network Controlled Interactive Services (NCIS). In the future, the NR SL may be enhanced further to address other UCs too.

In 3GPP plenary for the radio access network (RAN), discussions initiated in the meeting RAN #94 to identify detailed motivations and work areas for the evolution of NR SL in Release 18. For commercial sidelink applications, two key requirements were identified, including increased sidelink data rate and support for further carrier frequencies in sidelink, e.g., as is described in the 3GPP document RP-213678, on a “New WID on NR Sidelink Evolution”, RAN #94-e, 6-17 Dec. 2021. The increased data rate enables sharing of sensor information (e.g., video) between vehicles to enable a high degree of driving automation. It was also identified that data rates of commercial use cases required exceeded the requirements of what was possible in Release 17. Thus, increased data rate can be achieved with the support of sidelink carrier aggregation and sidelink over unlicensed spectrum.

Legacy standards and technology for vehicular communication (i.e., V2X standards) over a PC5 interface such as LTE V2X standards were specified to support only broadcast communications. In addition, the LTE SL CA as described in Section 2.1.2 was subsequently specified for broadcast to enable transmissions with high data rate or high transmission reliability over sidelink. However, in Release 16, NR V2X standards were specified to support in addition to broadcast, also unicast and groupcast communications. Further, in Release 18, the sidelink evolution feature aims to introduce the concept of carrier aggregation (CA) and operation of sidelink in the unlicensed spectrum to the NR V2X standards for all cast types (i.e., unicast, broadcast and groupcast). Furthermore, the objectives include the support for carrier aggregation/operation in unlicensed spectrum in both mode-1 (gNB control) and mode-2(UE autonomous) scenarios.

Carrier selection is an important step in the CA feature to provide high data rates/reliability by utilizing the different carriers for transmission. In LTE V2X, the specification was such that a sidelink UE can select any carrier out of the set of given configured carriers to perform carrier aggregation. However, in the case of NR V2X, this aspect has yet to be investigated thoroughly especially in the case of unicast because there was no support for this mode in the LTE V2X standards.

One of the issues in NR V2X sidelink CA could be that different UEs in the network may have different capabilities for supporting sidelink carrier frequencies. As a result, there might be a possibility that a UE for receiving data (RX UE) might not be able to support all or some of the carrier frequencies used by a UE for transmitting the data (TX UE). This is also because in the legacy standards and technology, the TX UE is unaware of the supported carriers at the RX UE side when performing its transmission.

In addition, for the case of mode 1, a network node serving a UE (e.g., a serving gNB) is also not aware of the RX UE's capabilities with regards to supported SL carrier frequencies. This would result in the gNB not being able to provide suitable Logical Channel (LCH) mapping restrictions to the TX UE considering the RX UE's capabilities for transmission.

A similar situation exists when sidelink is operated in an unlicensed spectrum, when the TX UE operating in a wideband mode comprises multiple contiguous carriers. In this case, there is a possibility that the RX UE cannot support all the carrier frequencies on which the TX UE can transmit and is also unaware of this information.

### SUMMARY

Accordingly, there is a need for a sidelink technique for diverse radio access capabilities of radio devices.

As to a first method aspect, a method performed by a transmitting radio device for transmitting data to a receiving radio device is provided. The method comprises receiving at least one of a radio access capability message indicative of a set of frequency resources supported by the receiving radio device and a configuration message indicative of a set of frequency resources configured for transmitting to the receiving radio device. The method further comprises transmitting data to the receiving radio device using at least one frequency resource from a set of frequency resources configured based on at least one of the received radio access capability message and the received configuration message.

The transmitting radio device may receive at least one of the radio access capability message and the configuration message. Herein, expressions such as “at least one of A, B, and C” may mean A and/or B and/or C (also briefly written as A, B, and/or C). The radio access capability message may be indicative of the set of frequency resources supported by the receiving radio device. Alternatively or in addition, the configuration message may be indicative of a set of frequency resources configured for transmitting to the receiving radio device (e.g., for a logical channel associated with the receiving radio device).

The transmitting radio device and the receiving radio device may be in device-to-device radio communication, which may herein be generically referred to as sidelink (e.g. a PC5 link or using a PC5 interface). The sidelink may comprise a direct radio link between the transmitting radio device and the receiving radio device or may comprise one or more relaying radio devices (also referred to as hops) between the transmitting radio device and the receiving radio device.

The radio access capability message may be indicative of a sidelink radio access capability of the receiving radio device and/or the radio access capability message may be indicative of frequency resources supported by the receiving radio device for a sidelink (e.g., between the transmitting radio device and the receiving radio device). The radio access capability message may also be referred to as sidelink radio access capability message.

The receiving radio device may also be referred to as the receiver or receiving user equipment (RX UE). Alternatively or in addition, the transmitting radio device may also be referred to as the transmitter or transmitting user equipment (TX UE).

The set of frequency resources supported by the receiving radio device may also be referred to as the supported frequency resources of the receiving radio device. Alternatively or in addition, the set of frequency resources configured based on the received radio access capability message may be referred to as the (e.g., set of) configured frequency resources or the (e.g., set of) frequency resources configured for transmitting to the receiving radio device or the configured carrier set (e.g., using an information element configuredcarrier).

The set of frequency resources configured based on the received radio access capability message may be configured (e.g., may be selected or reselected or may be result from restricting frequency resources) by the transmitting radio device.

Alternatively or in addition, the set of frequency resources configured based on the received radio access capability message may be applied by the transmitting radio device. Alternatively or in addition, the set of frequency resources configured based on the received radio access capability message may be configured by the receiving radio device (e.g., the radio access capability message may be a sidelink configuration message indicative of the set of configured frequency resources) or the set of frequency resources configured based on the received radio access capability message may be configured by a network node (e.g., responsive to a report of the radio access capability message).

Using at least one frequency resource from the set of frequency resources configured based on the received radio access capability message may mean that the transmission to the receiving radio device uses a (e.g., proper) subset of the set of frequency resources configured based on the received radio access capability message. Alternatively or in addition, the transmitting of the data to the receiving radio device may use only the at least one frequency resource from the set of frequency resources configured based on the received radio access capability message. Alternatively or in addition, the transmitting of the data to the receiving radio device may use the entire set of frequency resources configured based on the received radio access capability message.

The radio access capability message may be received on a sidelink from the receiving radio device. Alternatively or in addition, the data may be transmitted on the sidelink to the receiving radio device.

The radio access capability message may be directly received from the receiving radio device (e.g., on a sidelink) or indirectly through a network node (e.g., on a downlink). The network node may be a fifth generation node B (gNodeB or gNB).

The configured frequency resources (e.g., according to the first method aspect) may result from restricting frequency resources supported by the transmitting radio device based on the received radio access capability message.

The radio access capability message (e.g., according to the first method aspect) may be received from the receiving radio device, optionally on a sidelink from the receiving radio device and/or in response to a request or discovery message transmitted from the transmitting radio device.

The receiving radio device may unicast, groupcast or broadcast the radio access capability message. The radio access capability message may be, or may be in included in, a discovery message from the receiving radio device.

The radio access capability message may be exchanged (i.e., received at the transmitting radio device) over the sidelink. The sidelink may be a unicast communication and/or the radio access capability message may be unicast from the receiving radio device to the transmitting radio device. For example, the radio access capability message may be a radio resource control (RRC) message (e.g., a sidelink RRC message or PC5-RRC message).

Alternatively or in addition, the receiving radio device and the transmitting radio device may be in RRC connection (e.g., sidelink RRC connection or PC5-RRC connection).

The radio access capability message (e.g., according to the first method aspect) may be received from a network node, optionally from a network node serving at least one of the transmitting radio device and the receiving radio device.

The radio access capability message may be received in a downlink and/or over a Uu link and/or through the network node. For example, the radio access capability message may be transmitted from the receiving radio device to a network node serving the receiving radio device (e.g., to a radio access network, RAN, comprising the network node). Alternatively or in addition, the radio access capability message may be forwarded by the network node to the transmitting radio device.

Receiving the radio access capability message directly from the receiving radio device, e.g. exchanging over a PC5-link, may be only possible for a unicast (UC) communication between the transmitting radio device and the receiving radio device. For groupcast (GC) and broadcast (BC), the radio access capability message (e.g., over the PC5 link) may be indicative of a capability of the receiving radio device for groupcast and/or broadcast.

Alternatively or in addition, e.g. for any (e.g., sidelink) cast type, i.e. UC, GC and/or BC, the radio access capability message may be received through the network node.

The radio access capability message may be received via dedicated signaling (e.g., Uu-RRC signaling) and/or broadcast (e.g., via a system information block, SIB).

The frequency resources (e.g., according to the first method aspect) may comprise at least one of carriers, frequency bands, and subbands.

Any set of frequency resources (e.g., a set of frequency resources supported by the transmitting radio device, and/or the received set of frequency resources supported by the receiving radio device and/or the set of frequency resources configured for the transmitting to the receiving radio device) may comprise a set of carriers (e.g., component carriers) or a set of frequency bands or a set of subbands.

The transmitting of the data (e.g., according to the first method aspect) may use carrier aggregation. The frequency resources may comprise component carriers for the carrier aggregation.

The received set of frequency resources supported by the receiving radio device may be a set of component carriers supported by the receiving radio device for the carrier aggregation. Alternatively or in addition, the set of frequency resources configured based on the received radio access capability message (i.e., the frequency resources configured for the transmitting to the receiving radio device) may be a set of component carriers configured for the carrier aggregation involving the receiving radio device.

The carrier aggregation may use the set of frequency resources configured based on the received radio access capability message. The carrier aggregation may combine the frequency resources configured based on the received radio access capability message.

A logical channel (LCH) associated with the receiving radio device may be mapped to the set of frequency resources configured based on the received radio access capability message (e.g., according to the first method aspect).

The data arriving (e.g., for the transmitting) at the LCH associated with the receiving radio device may be mapped to at least one or multiple or all of the configured frequency resources. Herein, data arriving may encompass data pending for transmission or becoming available for transmission.

The configured frequency resources (e.g., according to the first method aspect) may be selected or reselected by the transmitting radio device based on the received radio access capability message.

The configured frequency resources may be selected or reselected for transmitting to the receiving radio device and/or for the carrier aggregation.

The frequency resources supported by the transmitting radio device may be supported for carrier aggregation and/or configured for the transmitting radio device irrespective of the receiving radio device. The frequency resources supported by the transmitting radio device may be restricted by the transmitting radio device for sidelink communication with the receiving radio device.

The transmitting radio device may restrict the frequency resources supported by the transmitting radio device. Alternatively or in addition, the method may comprise a step of restricting frequency resources supported by the transmitting radio device for transmitting based on the received radio access capability message or restricting frequency resources supported by the transmitting radio device for carrier aggregation based on the received radio access capability message.

The restricting (e.g., according to the first method aspect) may be performed in a logical channel prioritization (LCP) procedure at the transmitting radio device.

The transmitting radio device may use an autonomous resource selection, optionally according to mode 4 of 3GPP Long Term Evolution (LTE) or according to mode 2 of 3GPP New Radio (NR).

The method (e.g., according to the first method aspect) may further comprise reporting a layer 2 identifier (L2 ID) of the planned transmission and/or the received radio access capability message to a network node, optionally to a network node serving the transmitting radio device. The method may further comprise receiving a or the configuration message from the network node, the configuration message being indicative of the set of frequency resources configured based on the received radio access capability message.

Reporting the received radio access capability message may comprise reporting the set of frequency resources supported by the receiving radio device to the network node. Alternatively or in addition, the access capability message may be reported upon request (i.e., upon instructions) of the network node. Alternatively or in addition, the reporting may use radio resource control (RRC) signaling on an uplink to the network node (also referred to as Uu RRC signaling) and/or may be part of a sidelink UE information (SUI) message.

The configuration message may comprise downlink control information (DCI), optionally according to a DCI format (e.g., DCI format 5A of 3GPP LTE). Alternatively or in addition, the LCH associated with the receiving radio device may be configured (e.g., according to the configuration message received from the network node) with the set of frequency resources configured based on the received radio access capability message.

The transmitting radio device may use a resource allocation scheduled by the network node, optionally according to mode 3 of 3GPP Long Term Evolution (LTE) or according to mode 1 of 3GPP New Radio (NR).

The set of frequency resources configured based on the radio access capability message (e.g., according to the first method aspect) may be the received set of frequency resources supported by the receiving radio device or a subset of the received set of frequency resources supported by the receiving radio device.

The set of frequency resources configured based on the radio access capability message (e.g., according to the first method aspect) may be a combination, optionally an overlap or a union, between the received set of frequency resources supported by the receiving radio device and a set of frequency resources supported by the transmitting radio device.

The set of frequency resources supported by the transmitting radio device may be different from the received set of frequency resources supported by the receiving radio device. For example, the overlap may be an intersection of the sets.

The transmitting radio device (e.g., according to the first method aspect) may transmit to multiple receiving radio devices. The radio access capability message may be received from or for each of the multiple receiving radio devices. The set of configured frequency resources may be based on a combination of the received radio access capability messages or a combination of the received sets of frequency resources supported by the multiple receiving radio devices or an overlap of the received sets of frequency resources supported by the multiple receiving radio devices or a union of the received sets of frequency resources supported by the multiple receiving radio devices.

Each radio access capability message may be indicative of a set of frequency resources supported by the respective one of multiple receiving radio devices.

The transmission to the multiple receiving radio devices may or may not be a unicast transmission. For example, the same data may be transmitted to multiple receiving radio devices in a groupcast or broadcast transmission. Alternatively or in addition, different data may be transmitted to different receiving radio devices in (e.g., simultaneous or overlapping in time or subsequent) unicast transmissions.

The set of configured frequency resources may be restricted to an overlap of the frequency resources supported by each of the multiple receiving radio devices.

The configured frequency resources may comprise common frequency resources for the multiple receiving radio devices, i.e., frequency resources that are supported by all the multiple receiving radio devices.

By transmitting on the configured frequency resources that are based on the combination of the received radio access capability messages, the transmitting radio device may avoid switching between different carriers, frequency bands or subbands.

The set of configured frequency resources (e.g., the overlap) may be an intersection of the received sets. Alternatively or in addition, the set of configured frequency resources may be a union of the received sets.

The radio access capability message, or each of the radio access capability messages, (e.g., according to the first method aspect) may be further indicative of at least one of a sidelink cast type, a quality of service (QoS), a priority, a service, a traffic type, and an application. Optionally, the radio access capability message may be indicative (of any of the aforementioned items) for each of the frequency resources supported by the receiving radio device.

The radio access capability message, or each of the radio access capability messages, may comprise an index field and/or a layer 2 identifier (L2 ID) that is indicative of at least one of a sidelink cast type, a quality of service, a priority, a service, a traffic type, and an application.

The radio access capability message (e.g., according to the first method aspect) may comprise an index field and/or a layer 2 identifier (L2 ID). The index field and/or the L2 ID may be encoded according to a list of sidelink cast types, the list comprising at least one or all of unicast, groupcast, and broadcast. Alternatively or in addition, the index field and/or the L2 ID may be encoded according to a list comprising at least one or all of sidelink cast types, QoS requirements, priorities, services, traffic types, and applications. Alternatively or in addition, the radio access capability message may comprise an index field and/or L2 ID associated to each of the frequency resources supported by the receiving radio device.

The transmitting radio device may map different quality of services (QoSs), different priorities, different services, different traffic types, and/or different applications to different radio resources (e.g. to different carriers). Alternatively or in addition, the transmitting radio device may map the further indication (e.g., at least one of the QoS, the priority, the service, the traffic type, and the application, or the L2 ID thereof) to the frequency resources (e.g. carriers) configured based on the received radio access capability message.

The receiving radio device may support, provide, require or perform at least one of the sidelink cast type, the QoS, the priority, the service, the traffic type, and the application indicated in the radio access capability message.

The set of configured frequency resources (e.g., according to the first method aspect) may be selected based on at least one of the sidelink cast type, the quality of service, the priority, the service, the traffic type, and the application indicated in the received radio access capability message, optionally if there is no overlap between the received set of frequency resources supported by the receiving radio device and a set of frequency resources supported by the transmitting radio device and/or if there is no overlap between all the received sets of frequency resources supported by the multiple receiving radio devices.

The radio access capability message (e.g., according to the first method aspect) may be indicative of the receiving radio device supporting either a first frequency resource or a second frequency resource. Alternatively or in addition, the first frequency resource and the second frequency resource are separate and/or disjoint in the frequency domain and/or wherein a radio frequency of the first frequency resource is greater than a radio frequency of the second frequency resource.

The first frequency resource may be a first frequency band or a first carrier. The second frequency resource may be a second frequency band or a second carrier.

The radio access capability message (e.g., according to the first method aspect) may be indicative of the receiving radio device supporting either a first frequency resource or a second frequency resource. A radio frequency of the first frequency resource may be greater than a radio frequency of the second frequency resource.

The set of configured frequency resources may comprise the first frequency resource if the highest priority LCH associated with the receiving radio device has a data rate requirement, optionally according to the indicated quality of service. Alternatively or in addition, the set of configured frequency resources may comprise the second frequency resource if the highest priority LCH associated with the receiving radio device has a reliability requirement, optionally according to the indicated quality of service.

The overlap between the received set of frequency resources supported by the receiving radio device and the set of frequency resources supported by the transmitting radio device and/or the overlap between all the received sets of frequency resources supported by the multiple receiving radio devices (e.g., according to the first method aspect) may define a default set of frequency resources. Alternatively or in addition, the transmitting radio device may use the default set of frequency resources for at least one of: initiating or maintaining a sidelink between the transmitting radio device and the receiving radio device, synchronization with the receiving radio device, synchronization with all the receiving radio devices, transmitting a discovery message to the receiving radio device, transmitting a discovery message to all the receiving radio devices, receiving a discovery message from the receiving radio device, and receiving a discovery message from each of the receiving radio devices.

The set of configured frequency resources (e.g., according to the first method aspect) may be further restricted according to a number of radio frequency chains of the transmitting radio device.

The set of configured frequency resources may comprise a number of carriers that is equal to or less than the number of radio frequency chains of the transmitting radio device.

The transmitting radio device and the receiving radio device (e.g., according to the first method aspect) may operate in a shared radio spectrum. Alternatively or in addition, the sidelink between the transmitting radio device and the receiving radio device may use a or the shared radio spectrum.

The shared radio spectrum may be unlicensed spectrum. Alternatively or in addition, Alternatively or in addition, the shared radio spectrum may be radio spectrum that is shared by multiple radio access technologies (RATs), e.g., including 3GPP LTE and/or 3GPP NR and/or Wi-Fi. Alternatively or in addition, the shared radio spectrum may be radio spectrum in a 5 GHz band or a 6 GHz band or greater than 5 GHz or 6 GHz.

The set of configured frequency resources (e.g., according to the first method aspect) may be or may comprise a set of configured unlicensed subbands in a or the shared radio spectrum. Alternatively or in addition, a or the LCH associated with the receiving radio device may be mapped to a or the set of configured unlicensed subbands, optionally for transmitting the data arriving at the LCH in wideband operations.

The set of configured unlicensed subbands may be referred to, or configured, using an information element (IE) “configuredunlicensedsubbands”.

One configured frequency resource or a subset of configured frequency resources or all configured resources of the set of frequency resources configured based on the received radio access capability message (e.g., according to the first method aspect) may be selected by the transmitting radio device, optionally depending on at least one of a signal strength measured at the transmitting radio device for the receiving radio device; and a congestion level measured at the transmitting radio device.

The at least one frequency resource (e.g., according to the first method aspect) may be selected or reselected by the transmitting radio device from the set of frequency resources configured based on the received radio access capability message if a previously selected frequency resource is persistently not available.

The previously selected frequency resource (e.g., according to the first method aspect) may be the persistently not available, if at least one of a timer expires that was started upon arrival of the data to be transmitted at the LCH; the transmitting radio device is unable to transmit the data before a threshold of a packet delay budget (PDB) associated to the data; a number of times the transmitting radio device is unable to transmit the data before the threshold of the PDB associated to the data exceeds a predefined maximum; a signal strength measured on the previously selected frequency resource is less than a predefined minimum.

Herein, signal strength may encompass at least of, or a numerical combination of, reference signal received power (RSRP), reference signal received quality (RSRQ), received signal strength indicator (RSSI), signal to noise ratio (SNR), signal to interference ratio (SIR), and signal to interference and noise ratio (SINR).

The radio access capability message and/or the configuration message (e.g., according to the first method aspect) may be received from the network node at the transmitting radio device. Alternatively or in addition, the L2 ID of the planned transmission and/or the received radio access capability message may be reported from the transmitting radio device to the network node using at least one of radio resource control (RRC) signaling; medium access control (MAC) control element (CE); a paging message; a control protocol data unit (PDU) of a protocol layer; a PDU of a service data adaptation protocol (SDAP) layer; a PDU of a packet data convergence protocol (PDCP) layer; a PDU of a radio link control (RLC) layer; a PDU of an adaptation layer for a sidelink relay; physical layer signaling; downlink control information (DCI); signaling on a physical downlink control channel (PDCCH); signaling on a physical random access channel (PRACH); uplink control information (UCI); and signaling on a physical uplink control channel (PUCCH).

The radio access capability message (e.g., according to the first method aspect) may be received from the receiving radio device at the transmitting radio device using at least one of radio resource control (RRC) signaling, optionally sidelink RRC signaling or PC5 RRC signaling; PC5-S signaling; a discovery message; a medium access control (MAC) control element (CE); a control protocol data unit (PDU) of a protocol layer; a PDU of a service data adaptation protocol (SDAP) layer; a PDU of a packet data convergence protocol (PDCP) layer; a PDU of a radio link control (RLC) layer; a PDU of an adaptation layer for a sidelink relay; physical layer signaling; sidelink control information (SCI); signaling on a physical sidelink control channel (PSCCH); signaling on a physical sidelink feedback channel (PSFCH); signaling on a physical sidelink shared channel (PSSCH).

As to a second method aspect, a method performed by a receiving radio device for receiving data from a transmitting radio device is provided. The method comprises transmitting a radio access capability message, the radio access capability message being indicative of a set of frequency resources supported by the receiving radio device. The method further comprises receiving data from the transmitting radio device using at least one frequency resource from a set of frequency resources configured based on the transmitted radio access capability message.

The radio access capability message (e.g., according to the second method aspect) may be transmitted to the transmitting radio device, optionally unicasted, groupcasted or broadcasted by the receiving radio device and/or in response to a request or discovery message received from the transmitting radio device.

The radio access capability message (e.g., according to the second method aspect) may be transmitted to a network node, optionally to a network node serving at least one of the transmitting radio device and the receiving radio device.

The second method aspect may further comprise any feature and/or any step disclosed in the context of the first method aspect, or a feature and/or step corresponding thereto, e.g., a receiver counterpart to a transmitter feature or step.

As to a third method aspect, a method performed by a network node for configuring at least one of a transmitting radio device and a receiving radio device is provided. The method comprises receiving a radio access capability message, the radio access capability message being indicative of a set of frequency resources supported by the receiving radio device. The method further comprises transmitting the radio access capability message or a configuration message to at least one of the transmitting radio device and the receiving radio device, the configuration message being indicative of a set of frequency resources configured based on the received radio access capability message. The configuration message may configure the transmitting radio device for transmitting data to the receiving radio device using at least one frequency resource from the set of configured frequency resources. Alternatively or in addition, the configuration message may configure the receiving radio device for receiving data from the transmitting radio device using at least one frequency resource from the set of configured frequency resources.

The radio access capability message may be received directly from the receiving radio device. Alternatively or in addition, radio access capability message may be reported from the transmitting radio device. Alternatively or in addition, the radio access capability message may be received in a backhaul network or radio access network (RAN) from another network node. For example, a network node serving the receiving radio device may forward the radio access capability message to the network node serving the transmitting radio device.

The radio access capability messages (e.g., according to the third method aspect) may be received from multiple receiving radio devices, each of the radio access capability messages being indicative of a set of frequency resources supported by the respective receiving radio device.

For example, the network node may determine the configured frequency resources (e.g., by determining the overlap or the union) comprising one or more common frequency resources (e.g., carriers or frequency bands or subbands) for the multiple receiving radio devices, i.e., one or more frequency resources that are supported by all the multiple receiving radio devices) based on the radio access capability messages received from the multiple receiving radio devices.

Each of the multiple radio access capability messages (e.g., according to the third method aspect) may be associated with a groupcast service or a broadcast service or an L2 ID. The configuration message may configure the transmitting radio device for groupcasting or broadcasting the data to the multiple receiving radio devices using the at least one frequency resource from the set of configured frequency resources.

For example, each of the radio access capability messages (e.g., the L2 ID in the respective radio access capability message) may be indicative the groupcast service or the broadcast service.

The third method aspect may further comprise any feature and/or any step disclosed in the context of the first and/or second method aspect, or a feature and/or step corresponding thereto, e.g., a network counterpart to a radio device feature or step.

As to another aspect, a computer program product is provided. The computer program product comprises program code portions for performing any one of the steps of the first method aspect, the second method aspect, and/or the third method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a transmitting radio device for transmitting data to a receiving radio device is provided. The transmitting radio device comprises memory operable to store instructions and processing circuitry operable to execute the instructions, such that the transmitting radio device is operable to receive at least one of a radio access capability message indicative of a set of frequency resources supported by the receiving radio device and a configuration message indicative of a set of frequency resources configured for transmitting to the receiving radio device. The transmitting radio device is further operable to transmit data to the receiving radio device using at least one frequency resource from a set of frequency resources configured based on at least one of the received radio access capability message and the received configuration message.

The transmitting radio device (e.g., according to the first device aspect) may be further operable to perform any one of the steps of the first method aspect.

As to a further first device aspect, a device comprises processing circuitry (e.g., at least one processor and a memory). Said memory comprises instructions executable by said at least one processor whereby the device is operative to perform any one of the steps of the first method aspect.

As to another first device aspect, a transmitting radio device for transmitting data to a receiving radio device is provided. The transmitting radio device is configured to receive at least one of a radio access capability message indicative of a set of frequency resources supported by the receiving radio device and a configuration message indicative of a set of frequency resources configured for transmitting to the receiving radio device. The transmitting radio device is further configured to transmit data to the receiving radio device using at least one frequency resource from a set of frequency resources configured based on at least one of the received radio access capability message and the received configuration message.

The transmitting radio device (e.g., according to the other first device aspect) may be further configured to perform any one of the steps of the first method aspect. As to a second device aspect, a receiving radio device for receiving data from a transmitting radio device is provided. The receiving radio device comprising memory operable to store instructions and processing circuitry operable to execute the instructions, such that the receiving radio device is operable to transmit a radio access capability message, the radio access capability message being indicative of a set of frequency resources supported by the receiving radio device. The radio device is further operable to receive data from the transmitting radio device using at least one frequency resource from a set of frequency resources configured based on the transmitted radio access capability message.

The receiving radio device (e.g., according to the second device aspect) may be further operable to perform any one of the steps of the second method aspect.

As to a further second device aspect, a device comprises processing circuitry (e.g., at least one processor and a memory). Said memory comprises instructions executable by said at least one processor whereby the device is operative to perform any one of the steps of the second method aspect.

As to another second device aspect, a receiving radio device for receiving data from a transmitting radio device is provided. The receiving radio device is configured to transmit a radio access capability message, the radio access capability message being indicative of a set of frequency resources supported by the receiving radio device. The receiving radio device is further configured to receive data from the transmitting radio device using at least one frequency resource from a set of frequency resources configured based on the transmitted radio access capability message.

The receiving radio device (e.g., according to the other second device aspect) may further configured to perform any one of the steps of second method aspect.

As to a third device aspect, a network node for configuring at least one of a transmitting radio device and a receiving radio device is provided. The network node comprises memory operable to store instructions and processing circuitry operable to execute the instructions, such that the network node is operable to receive a radio access capability message, the radio access capability message being indicative of a set of frequency resources supported by the receiving radio device. The network node is further operable to transmit the radio access capability message or a configuration message to at least one of the transmitting radio device and the receiving radio device, the configuration message being indicative of a set of frequency resources configured based on the received radio access capability message. The configuration message configures the transmitting radio device for transmitting data to the receiving radio device using at least one frequency resource from the set of configured frequency resources and/or wherein the configuration message configures the receiving radio device for receiving data from the transmitting radio device using at least one frequency resource from the set of configured frequency resources.

The network node (e.g., according to the third device aspect) may be further operable to perform any one of the steps of the third method aspect.

As to a further third device aspect, a device comprises processing circuitry (e.g., at least one processor and a memory). Said memory comprises instructions executable by said at least one processor whereby the device is operative to perform any one of the steps of the third method aspect.

As to another third device aspect, a network node for configuring at least one of a transmitting radio device and a receiving radio device is provided. The network node is configured to receive a radio access capability message, the radio access capability message being indicative of a set of frequency resources supported by the receiving radio device. The network node is further configured to transmit the radio access capability message or a configuration message to at least one of the transmitting radio device and the receiving radio device, the configuration message being indicative of a set of frequency resources configured based on the received radio access capability message. The configuration message configures the transmitting radio device for transmitting data to the receiving radio device using at least one frequency resource from the set of configured frequency resources and/or wherein the configuration message configures the receiving radio device for receiving data from the transmitting radio device using at least one frequency resource from the set of configured frequency resources.

The network node (e.g., according to the other third device aspect) may be further configured to perform any one of the steps of the third method aspect.

As to a system aspect a communication system is provided. The communication system including a host computer comprises processing circuitry configured to provide user data. The communication system further comprises a communication interface configured to forward user data to a cellular or ad hoc radio network for transmission to a user equipment (UE). The UE comprises a radio interface and processing circuitry, the processing circuitry of the UE being configured to execute any one of the steps of the first method aspect and/or the second method aspect.

The communication system (e.g., according to the system aspect) may further include the UE (e.g., according to the first device aspect).

The radio network (e.g., according to the system aspect) may further comprises a base station, or a radio device functioning as a gateway, which is configured to communicate with the UE.

The base station or the radio device functioning as a gateway (e.g., according to the system aspect) may comprise processing circuitry, which is configured to execute any one of the steps of the third method aspect.

The processing circuitry of the host computer (e.g., according to the system aspect) may be configured to execute a host application, thereby providing the user data. Alternatively or in addition, the processing circuitry of the UE (e.g., according to the system aspect) may be configured to execute a client application associated with the host application.

Any aspect may be embodied by a carrier selection mechanism in sidelink (SL). Herein, SL may encompass any wireless device-to-device (D2D) communication. Any embodiment may use New Radio (NR) SL for communication between the transmitting radio device and the receiving radio device. Optionally, the data transmission may use carrier aggregation (CA) in accordance with the set of configured frequency resources resulting from any one of the method aspects. Alternatively or in addition, any embodiment may be configured for unlicensed operation or may use a shared radio spectrum. For example, the set of configured frequency resources resulting from any one of the method aspects may be in unlicensed spectrum or shared radio spectrum.

The technique (i.e., an embodiment of any one of the aspects or a system comprising embodiments of at least two or all three aspects) may be applied in the context of 3GPP New Radio (NR). Unlike a SL according to 3GPP LTE, a SL according to 3GPP NR can provide a wide range of QoS levels. Therefore, at least some embodiments of the technique can ensure that the data is transmitted or received in fulfilment of the QoS associated with the data.

Herein, the frequency resources may be or may comprise carriers (e.g., component carriers for carrier aggregation, CA), frequency bands, and/or subbands (e.g., in unlicensed spectrum). The carriers may be contiguous carriers.

The technique may be implemented in accordance with a 3GPP specification, e.g., for 3GPP release 18. At least some embodiments may be implemented based on the 3GPP document TS 38.321, version 16.7.0, or modification thereof, e.g., for Release 18.

In any radio access technology (RAT, e.g. LTE, NR or Wi-Fi), the technique may be implemented for SL carrier selection. The SL may be implemented using proximity services (ProSe), e.g. according to a 3GPP specification.

Any radio device may be a user equipment (UE), e.g., according to a 3GPP specification. The transmitting radio device may also be referred to as a transmitting UE (or briefly: TX UE or transmitter). Alternatively or in addition, the receiving radio device may also be referred to as a receiving UE (or briefly RX UE or receiver). Alternatively or in addition, any further radio device may also be referred to as a further UE.

The transmitting radio device and a network node (e.g., of a radio access network, RAN) and/or a receiving radio device and a network node (e.g., the same network node or another network node of the same RAN) may be wirelessly connected in an uplink (UL) and/or a downlink (DL) through a Uu interface. Alternatively or in addition, the SL may enable a direct radio communication between proximal radio devices, e.g., the transmitting radio device and the receiving radio device, optionally using a PC5 interface. Services provided using the SL or the PC5 interface may be referred to as proximity services (ProSe). Any radio device (e.g., the transmitting radio device and/or the receiving radio device and/or the further radio device) supporting a SL may be referred to as ProSe-enabled radio device.

At least one of the transmitting radio device and the receiving radio device may further function as a relay radio device (e.g., ProSe UE-to-Network Relay) or the radio communication between the transmitting radio device and the receiving radio device may be relayed through one or more relay radio devices.

The transmitting radio device and/or the receiving radio device and/or the network node (e.g., the RAN) and/or one or more further radio devices may form, or may be part of, a radio network, e.g., according to the Third Generation Partnership Project (3GPP) or according to the standard family IEEE 802.11 (Wi-Fi).

The first method aspect, the second method aspect and third method aspect may be performed by one or more embodiments of the transmitting radio device, the receiving radio device and the network node (e.g., a base station) or the further radio device, respectively.

The RAN may comprise one or more network nodes (e.g., base stations) performing the third method aspect. Alternatively or in addition, the radio network may be a vehicular, ad hoc and/or mesh network comprising two or more radio devices, e.g., acting as the transmitting radio device and/or the receiving radio device and/or the further radio device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more embodiments of the network node (e.g., base stations).

The transmitting radio device may be wirelessly connected or connectable (e.g., according to a radio resource control, RRC, state or active mode) with the receiving radio device and, optionally, at least one network node of the RAN. The receiving radio device may be wirelessly connected or connectable (e.g., according to a radio resource control, RRC, state or active mode) with at least one network node of the RAN and/or a further radio device.

The network node (e.g. base station) may encompass any station that is configured to provide radio access to any of the radio devices. The network node may define, or may also be referred to as, a cell, a transmission and reception point (TRP), a radio access node or an access point (AP). The network node and/or the transmitting or receiving radio device (e.g., acting as a relay radio device) may provide a data link to a host computer providing the data (e.g., user data) to the receiving radio device or gathering the data (e.g., user data) from the transmitting radio device. Examples for the network node (e.g., base station) may include a 3G base station or Node B (NB), 4G base station or eNodeB (eNB), a 5G base station or gNodeB (gNB), a Wi-Fi AP, and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

Any one of the devices (e.g., radio devices or UEs), the network node (e.g., a base station), the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for transmitting data from a transmitting radio device to a receiving radio device;

FIG. 2 shows a schematic block diagram of an embodiment of a device for receiving data from a transmitting radio device at a receiving radio device;

FIG. 3 shows a schematic block diagram of an embodiment of a device for configuring at least one of a transmitting radio device and a receiving radio device;

FIG. 4 shows a flowchart for a method of transmitting data from a transmitting radio device to a receiving radio device, which method may be implementable by the device of FIG. 1;

FIG. 5 shows a flowchart for a method of receiving data from a transmitting radio device at a receiving radio device, which method may be implementable by the device of FIG. 2;

FIG. 6 shows a flowchart for a method of configuring at least one of a transmitting radio device and a receiving radio device, which method may be implementable by the device of FIG. 3;

FIG. 7 schematically illustrates an example of a radio network comprising embodiments of the devices of FIGS. 1, 2, and 3 for performing the methods of FIGS. 4, 5, and 6, respectively;

FIG. 8A schematically illustrates a signaling diagram resulting from first embodiments of the devices of FIGS. 1, 2, and 3 performing the methods of FIGS. 4, 5, and 6, respectively, in radio communication;

FIG. 8B schematically illustrates a signaling diagram resulting from second embodiments of the devices of FIGS. 1, 2, and 3 performing the methods of FIGS. 4, 5, and 6, respectively, in radio communication;

FIG. 9 schematically illustrates an example of logical channels (LCH), which may be used in embodiments of the devices of FIGS. 1, 2, and 3 for performing the methods of FIGS. 4, 5, and 6, respectively;

FIG. 10 shows a schematic block diagram of a remote radio device embodying the device of FIG. 1;

FIG. 11 shows a schematic block diagram of a relay radio device embodying the device of FIG. 2;

FIG. 12 shows a schematic block diagram of a radio access network embodying the device of FIG. 3;

FIG. 13 schematically illustrates an example telecommunication network connected via an intermediate network to a host computer;

FIG. 14 shows a generalized block diagram of a host computer communicating via a base station or radio device functioning as a gateway with a user equipment over a partially wireless connection; and

FIGS. 15 and 16 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

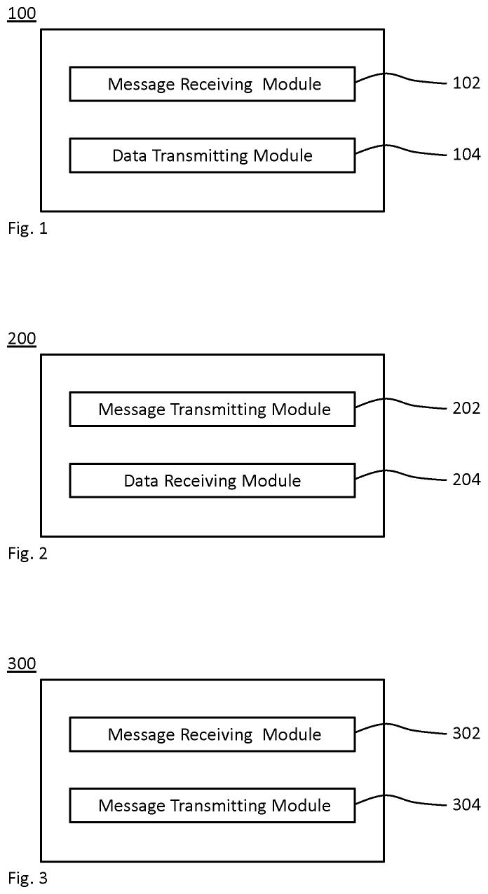

FIG. 1 schematically illustrates a block diagram of an embodiment of a device according to the first aspect. The device is generically referred to by reference sign 100.

The device 100 comprises a message receiving module 102, which receives at least one of a radio access capability message indicative of a set of frequency resources supported by the receiving radio device and a configuration message indicative of a set of frequency resources configured for transmitting to the receiving radio device. The device 100 further comprises a data transmitting module 104 that transmits data to the receiving radio device using at least one frequency resource from a set of frequency resources configured based on at least one of the received radio access capability message and the received configuration message.

Any of the modules of the device 100 may be implemented by units configured to provide the corresponding functionality.

The device 100 may also be referred to as, or may be embodied by, a transmitting station (or briefly: transmitter) or transmitting radio device (or TX UE). The transmitting radio device 100 and the receiving radio device may be in direct radio communication, e.g., at least for the data transmission from the transmitting radio device 100 to the receiving radio device. The receiving radio device may be embodied by the below device 200.

FIG. 2 schematically illustrates a block diagram of an embodiment of a device according to the second aspect. The device may be generically referred to by reference sign 200.

The device 200 comprises a message transmitting module 202, which transmits a radio access capability message, the radio access capability message being indicative of a set of frequency resources supported by the receiving radio device. The device 00 further comprises a data receiving module 204 that receives data from the transmitting radio device using at least one frequency resource from a set of frequency resources configured based on the transmitted radio access capability message.

Any of the modules of the device 200 may be implemented by units configured to provide the corresponding functionality.

The device 200 may also be referred to as, or may be embodied by, a receiving station (or briefly: receiver) or receiving radio device (or RX UE). The transmitting radio device and the receiving radio device 200 may be in direct radio communication, e.g., at least for the data reception from the transmitting radio device at the receiving radio device 200. The transmitting radio device may be embodied by the above device 100.

FIG. 3 schematically illustrates a block diagram of an embodiment of a device according to the third aspect. The device may be generically referred to by reference sign 300.

The device 300 comprises a message receiving module 302 indicated in FIG. 3, which receives a radio access capability message, the radio access capability message being indicative of a set of frequency resources supported by the receiving radio device. The device further comprises a message transmitting module 304 that transmits the radio access capability message or a configuration message to at least one of the transmitting radio device and the receiving radio device, the configuration message being indicative of a set of frequency resources configured based on the received radio access capability message, wherein the configuration message configures the transmitting radio device for transmitting data to the receiving radio device using at least one frequency resource from the set of configured frequency resources and/or wherein the configuration message configures the receiving radio device for receiving data from the transmitting radio device using at least one frequency resource from the set of configured frequency resources.

Any of the modules of the device 300 may be implemented by units configured to provide the corresponding functionality.

The device 300 may also be referred to as, or may be embodied by, a network node (e.g., a base station or gNB or eNB). The transmitting radio device and/or the receiving radio device may be in direct radio communication with the network node, e.g., at least for receiving or transmitting the configuration message and/or the radio access capability message. The transmitting radio device may be embodied by the above device 100. The receiving radio device may be embodied by the above device 200.

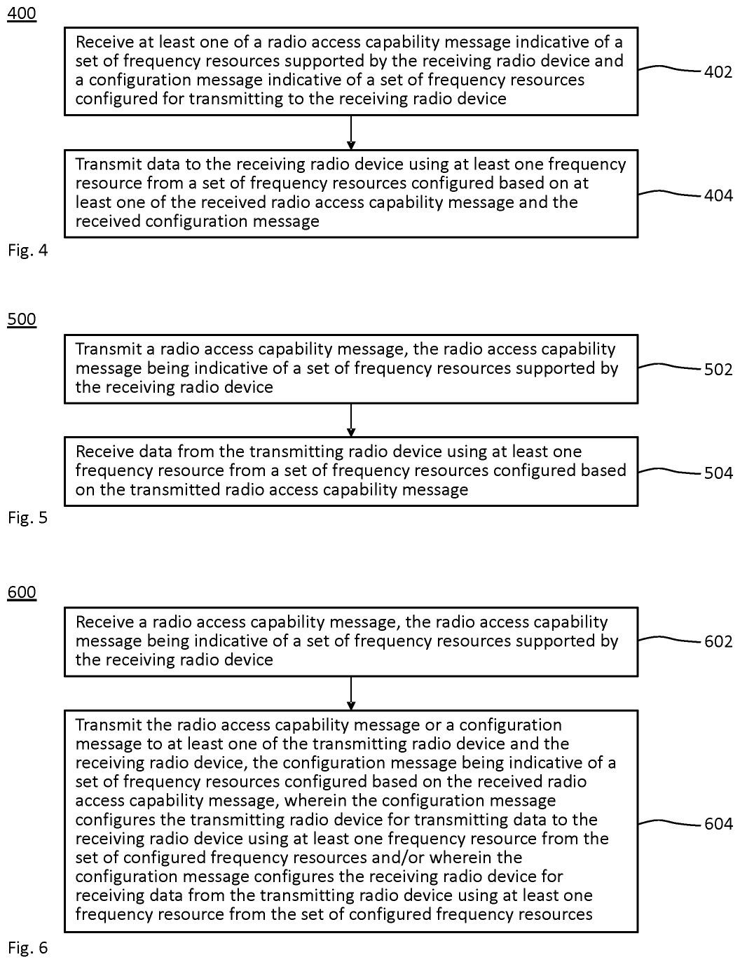

FIG. 4 shows an example flowchart for a method 400 according to the first method aspect. The method 400 comprises the steps indicated in FIG. 4.

The method 400 may be performed by the device 100. For example, the modules 102 and 104 may perform the steps 402 and 404, respectively.

FIG. 5 shows an example flowchart for a method 500 according to the second method aspect. The method 500 comprises the steps indicated in FIG. 5.

The method 500 may be performed by the device 200. For example, the modules 202 and 204 may perform the steps 502 and 504, respectively.

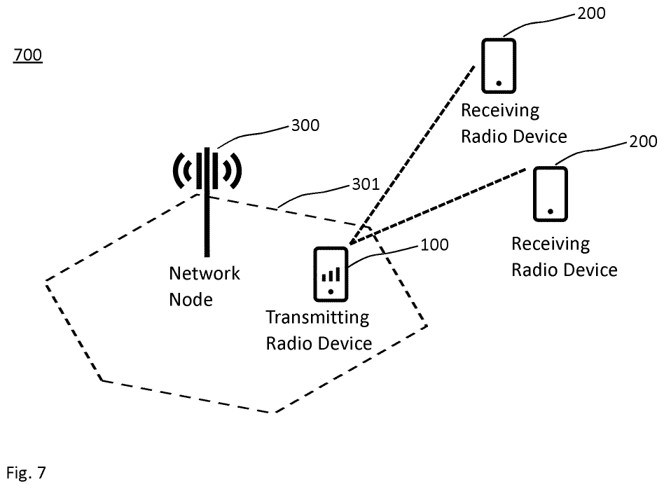

FIG. 6 shows an example flowchart for a method 600 according to the third method aspect. The method 600 comprises the steps indicated in FIG. 6.

The method 600 may be performed by the device 300. For example, the modules 302 and 304 may perform the steps 602 and 604, respectively.

In any aspect, the technique may use uplink (UL), downlink (DL) or direct communications between radio devices, e.g., device-to-device (D2D) communications or sidelink (SL) communications.

Each of the transmitting radio device 100 and receiving radio device 200 may be referred to as a radio device. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection.

Furthermore, any network node 300 (e.g., base station) may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR).

Embodiments of the technique enables a TX UE 100 to perform sidelink carrier selection considering the capabilities (e.g., in terms of band combinations and/or carrier combinations and/or subband combinations) of the corresponding (e.g., peer) RX UE 200. For example, the TX UE 100 restricts transmissions to only those bands and/or carriers (e.g., out of all the bands and/or carriers which are configured for CA), which the RX UE 200 can support or supports.

The restriction itself may be done as a part of a logical channel prioritization (LCP) procedure at the TX UE 100. For example, the data arriving at a logical channel (LCH) associated to a particular (peer) RX UE 200 is restricted to be carried on only a set of carriers hereby known as a configuredcarrier set, wherein this set is applied and/or configured (e.g., by the TX UE 100) according to the band capabilities and/or carrier capabilities of the RX UE 200.

The data arriving at the LCH can be mapped to one or many or all the carriers in the configuredcarrier set. Alternatively or in addition, when operating in the unlicensed spectrum, the LCP procedure restricts the data arriving at the LCH to only a set of subbands hereby known as the configuredunlicensedsubband set. Embodiments of the technique comprise detail methods for applying the restrictions on a LCH. The restrictions may be configured and/or applied by the TX UE 100 autonomously and/or under the instructions of the network node 300 (e.g., a gNB).

Alternatively or in addition, any aspect of the technique may comprise configuration and/or application of a set of configured carriers (“configured carriers”) or configured unlicensed subbands (“configuredunlicensedsubbands”) at setup of the TX UE 100 based on the band combinations and/or carrier frequencies capabilities and/or subband capabilities of the one or more corresponding (e.g., peer) RX UEs 200.

FIG. 7 schematically illustrates an example of a radio network 700 comprising embodiments of the transmitting radio device 100, one or more receiving radio devices 200, and optionally the network node 300. The network node 300 provides coverage in at least one cell 301.

While FIG. 7 illustrates only the transmitting radio device 100 being in coverage of the radio network 700, in an alternative example, only the receiving radio device 200 is in coverage of the radio network 700, or both are.

A (e.g., unicast) sidelink is illustrated by means of a dashed line between the radio devices.

Herein below, for concreteness and brevity and without loss of generality, the transmitting radio device 100, the receiving radio device 200 and the network node 300 are referred to as TX UE 100, RX UE 200 and the NW 300 (or gNB 300). Furthermore, the set of configured frequency resources (i.e., the configured set) may be referred to as configuredcarriers (or configuredcarrier set) or configuredunlicensedsubbands (or configuredunlicensedsubbands set), e.g., depending on whether the radio device operate in unlicensed spectrum.

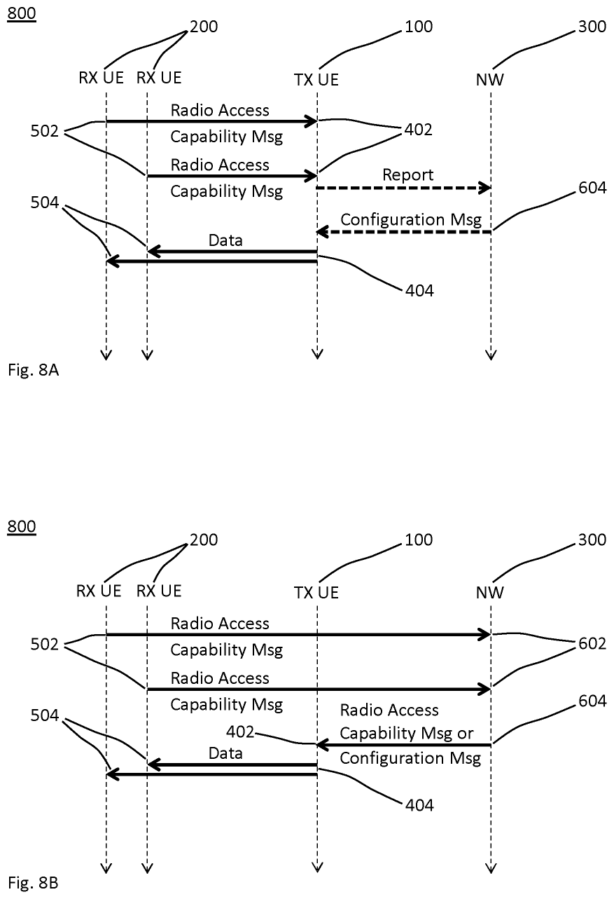

FIG. 8A schematically illustrates a signaling diagram 800 resulting from first embodiments of the TX UE 100 and the RX UEs 200 performing the methods 400 and 500, respectively, optionally involving the NW 300.

Each of the RX UEs 200 unicasts its radio access capability message to the TX UE 100 according to the steps 402 and 502. The TX UE 100 may determine the configured set autonomously. Alternatively or in addition, the TX UE 100 reports the supported sets of the RX UEs 200 received in the step 402 to the NW 300, which determines the configure set and configures the TX UE 100 accordingly by means of a configuration message in the step 604.

In any case, the determining (at the TX UE 100 or at the NW 300) may include determining an overlap or a union of the supported sets, optionally taking a priority or QoS or packet delay budget (PDB) into account.

FIG. 8B schematically illustrates a signaling diagram 800 resulting from second embodiments of the TX UE 100, the RX UEs 200, and the NW 300 performing the methods 400, 500, and 600, respectively.

Each of the RX UEs 200 transmits its radio access capability message to the NW 300 (which may be received by the same network node or different network nodes of the same RAN 700).

In the step 604, the NW 300 either forwards the radio access capability messages to the TX UE 100 for determining the configured set at the TX UE 100 or transmits a configuration message that is indicative of the configured set. The forwarded radio access capability messages or the configuration message is received in the step 402 at the TX UE 100.

The TX UE 100 transmits the data to the RX UEs 100 using the configured set, i.e., at least one frequency resource out of the set of configured frequency resources in the step 404.

Any embodiment may use sidelink carrier aggregation (SL CA), e.g., in the step 404 of transmitting and receiving the data. The SL CA (or herein briefly: CA) may implement at least one of the following features and steps.

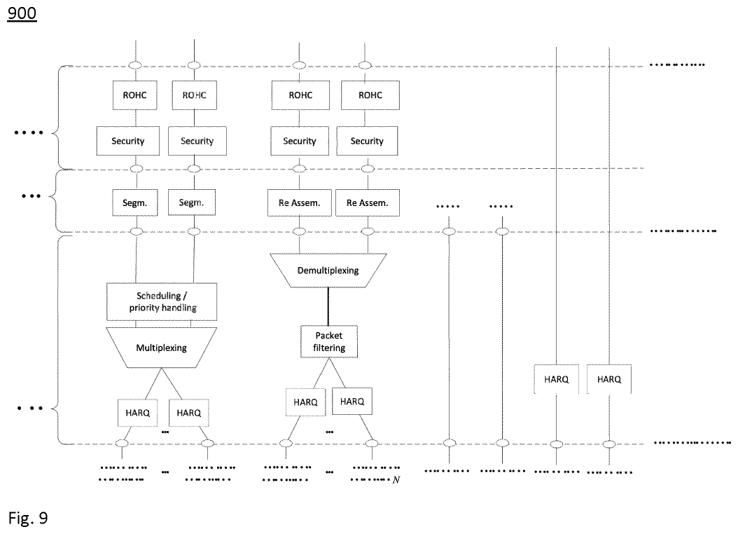

FIG. 9 (or FIGS. 6.4-3 in the 3GPP document TS 36.300, version 16.7.0) schematically illustrate a Layer 2 Structure for a sidelink configured with CA.

In case of carrier aggregation (CA) in sidelink, e.g. according to the 3GPP document TS 36.300 version 16.7.0, which applies to V2X sidelink communication, there is one independent HARQ entity per carrier used for V2X sidelink communication and one transport block is generated per TTI per carrier. Each transport block and its potential HARQ retransmissions are mapped to a single carrier.

Sidelink packet duplication is supported for V2X sidelink communication and is performed at PDCP layer of the UE. For sidelink packet duplication for transmission, a PDCP PDU is duplicated at the PDCP entity. The duplicated PDCP PDUs of the same PDCP entity are submitted to two different RLC entities and associated to two different sidelink logical channels respectively. The duplicated PDCP PDUs of the same PDCP entity are only allowed to be transmitted on different sidelink carriers. A UE can activate or deactivate sidelink packet duplication based on (pre)configuration. Sidelink packet duplication does not apply to transmission with Release 14 transmit profile (e.g., according to the 3GPP document TS 23.285, version 17.0.0). One or more values for a ProSe Per-Packet Reliability (PPPR), also referred to as PPPR value(s), for which sidelink packet duplication is supported can be (pre)configured via a PPPR threshold. For UE autonomous resource selection and scheduled resource allocation, the UE shall perform sidelink packet duplication for the data with the configured PPPR value(s) until packet duplication is de-configured for these PPPR value(s). For scheduled resource allocation, the UE reports the amount of data associated with one or more PPPR values, and the destination(s) to which the data belongs via sidelink BSR(s). A mapping of PPPR values to logical channel groups can be configured by the eNB, and the PPPR value(s) are reflected by the associated logical channel group ID included in the sidelink BSR(s). A list of PPPR value(s) may be reported in Sidelink UE information by an RRC_CONNECTED UE.

For a UE using scheduled resource allocation, two non-overlapped sets of carriers are configured by the eNB per destination reported by the UE to the network, and they apply to all the PPPR(s) that are configured for sidelink packet duplication. The UE then associates two duplicated sidelink logical channels corresponding to the same PDCP entity respectively with the two sets of carriers configured for the Destination of the two sidelink logical channels. The association between the duplicated sidelink logical channel and the carrier set is up to UE implementation. Data of a duplicated sidelink logical channel can only be transmitted on the carrier(s) in the associated carrier set.

For V2X sidelink communication reception, packet duplication detection is performed at PDCP layer of the UE. Reordering function is also supported at PDCP layer and how to set the reordering timer at the PDCP layer is up to UE implementation. There are specific logical channel identities which apply to the sidelink logical channel used for sidelink packet duplication exclusively as specified in the 3GPP document TS 36.321, e.g., version 16.7.0.

Any embodiment may use sidelink carrier selection (e.g., in LTE V2X).

Sidelink carrier aggregation (CA) is supported for V2X sidelink communication in LTE. For a Tx UE using scheduled resource allocation (i.e., mode 3 in LTE and mode 1 in NR), the Tx carrier is selected by the gNB and informed to the UE using DCI format 5A along with carrier indicator field (CIF) which indicates the PC5 carrier to be used for PSSCH transmission. For a Tx UE using autonomous resource selection (i.e., mode 4 in LTE and mode 2 in NR), it performs Tx carrier selection by itself and may select one or more carriers for its V2X sidelink transmission, e.g., according to the 3GPP document TS 36.321, version 16.6.0, on “Evolved Universal Terrestrial Radio Access (E-UTRA); Medium Access Control (MAC) protocol specification”. TX carrier (re-)selection is triggered for a STCH (Sidelink Traffic Channel, the sidelink logical channel carrying MAC CE or traffic from higher layer) and/or a carrier when any of the following conditions are met:
No configured sidelink grant on any carrier allowed for the STCH as indicated by upper layers.
The MAC entity selects to create a configured sidelink grant corresponding to transmissions of multiple MAC PDUs, data is available in STCH associated with one or multiple carriers, and the configured sidelink grant becomes invalid (i.e. resource reselection is triggered) in the carriers.
The MAC entity selects to create a configured sidelink grant corresponding to transmission(s) of a single MAC PDU, and data is available in STCH associated with one or multiple carriers.

If TX carrier (re-)selection (i.e., the step of selecting or reselecting performed by the TX UE 100) is triggered, the MAC entity shall:
if there is no configured sidelink grant on any carrier allowed for the sidelink logical channel where data is available as indicated by upper layers (e.g. SL-AllowedCarrierFreqList in the 3GPP document TS 36.321, version 16.6.0, on “Evolved Universal Terrestrial Radio Access (E-UTRA); Medium Access Control (MAC) protocol specification”):
   for each carrier configured by upper layers associated with the concerned sidelink logical channel:
      if the CBR of the carrier is below threshCBR-FreqReselection associated with the priority of the sidelink logical channel:
         consider the carrier as a candidate carrier for TX carrier (re-)selection for the concerned sidelink logical channel.
else:
   for each sidelink logical channel, if any, where data is available and that is allowed on the carrier for which Tx carrier (re-)selection is triggered:
      if the CBR of the carrier is below threshCBR-FreqKeeping associated with priority of the sidelink logical channel:
         select the carrier and the associated pool of resources.
      else:
         for each carrier configured by upper layers on which the sidelink logical channel is allowed, if the CBR of the carrier is below threshCBR-FreqReselection associated with the priority of the sidelink logical channel;
         consider the carrier as a candidate carrier for TX carrier (re-)selection.

If one or more carriers are considered as the candidate carriers for TX carrier (re-)selection, the MAC entity shall:
for each sidelink logical channel allowed on the carrier where data is available and Tx carrier (re-)selection is triggered:
   select one or more carrier(s) and associated pool(s) of resources among the candidate carriers with increasing order of CBR from the lowest CBR.
   It is left to UE implementation how many carriers to select based on UE capability.

Any one of the embodiments may use sidelink logical channel prioritization (LCP), e.g. in the step 404.

In any embodiment, one or more logical channels (LCH) may be selected (i.e., selection of logical channels) according to the 3GPP document TS 38.321, version 16.7.0, on “NR; Medium Access Control (MAC) protocol specification” of at least one of the following steps.
The MAC entity shall for each SCI corresponding to a new transmission:
1> select a Destination associated to one of unicast, groupcast and broadcast, having at least one of the MAC CE and the logical channel with the highest priority, among the logical channels that satisfy all the following conditions and MAC CE(s), if any, for the SL grant associated to the SCI:
   2> SL data is available for transmission; and
   2> SBj>0, in case there is any logical channel having SBj>0; and
   2> sl-configuredGrantType1Allowed, if configured, is set to true in case the SL grant is a Configured Grant Type 1; and
   2> sl-AllowedCG-List, if configured, includes the configured grant index associated to the SL grant; and
   2> sl-HARQ-FeedbackEnabled is set to disabled, if PSFCH is not configured for the SL grant associated to the SCI.

NOTE 1: If multiple Destinations have the logical channels satisfying all conditions above with the same highest priority or if multiple Destinations have either the MAC CE and/or the logical channels satisfying all conditions above with the same priority as the MAC CE, which Destination is selected among them is up to UE implementation.
1> select the logical channels satisfying all the following conditions among the logical channels belonging to the selected Destination:
   2> SL data is available for transmission; and
   2> sl-configuredGrantType1Allowed, if configured, is set to true in case the SL grant is a Configured Grant Type 1; and.
   2> sl-AllowedCG-List, if configured, includes the configured grant index associated to the SL grant; and
      3> if PSFCH is configured for the sidelink grant associated to the SCI:
         4> sl-HARQ-FeedbackEnabled is set to enabled, if sl-HARQ-FeedbackEnabled is set to enabled for the highest priority logical channel satisfying the above conditions; or
         4> sl-HARQ-FeedbackEnabled is set to disabled, if sl-HARQ-FeedbackEnabled is set to disabled for the highest priority logical channel satisfying the above conditions.
      3> else:
         4> sl-HARQ-FeedbackEnabled is set to disabled.

NOTE 2: sl-HARQ-FeedbackEnabled is set to disabled for the transmission of a MAC PDU only carrying CSI reporting MAC CE.

In any embodiment, the radio access capability message may be trigged by a UE Capability Enquiry, or an extension thereof.

For example, any embodiment may perform or trigger actions related to transmission of the UECapabilityEnquirySidelink by the UE.

The initiating UE shall set the contents of UECapabilityEnquirySidelink message as follows:
1> include in UE radio access capabilities for sidelink within ueCapabilitylnformationSidelink, if needed;
NOTE 1: It is up to initiating UE to decide whether ueCapabilitylnformationSidelink should be included.
1> set frequencyBandListFilterSidelink to include frequency bands for which the peer UE is requested to provide supported bands and band combinations;
NOTE 2: The initiating UE is not allowed to send the UECapabilityEnquirySidelink message without including the field frequencyBandListFilterSidelink.
1> submit the UECapabilityEnquirySidelink message to lower layers for transmission.

Alternatively or in addition, any embodiment may perform or trigger actions related to reception of the UECapabilityEnquirySidelink by the UE.

The peer UE shall set the contents of UECapabilitylnformationSidelink message as follows:
1> include UE radio access capabilities for sidelink within ueCapabilitylnformationSidelink;
1> compile a list of “candidate band combinations” only consisting of bands included in frequencyBandListFilter, and prioritized in the order of frequencyBandListFilterSidelink (i.e. first include band combinations containing the first-listed band, then include remaining band combinations containing the second-listed band, and so on).
1> include into supportedBandCombinationListSidelinkNR as many band combinations as possible from the list of “candidate band combinations”, starting from the first entry;
1> include the received frequencyBandListFilter in the field appliedFreqBandListFilter of the requested UE capability;
1> submit the UECapabilitylnformationSidelink message to lower layers for transmission.
NOTE: If the UE cannot include all band combinations due to message size or list size constraints, it is up to UE implementation which band combinations it prioritizes.

The present disclosure is described in the context of NR sidelink (SL) communications. However, most of the embodiments are in general applicable to any kind of direct communications between UEs involving device-to-device (D2D) communications such as LTE SL. Embodiments are described from a TX UE 100 and RX UE 200 point of view, which implies disclosure of corresponding features and steps at the NW 300. Further, it is assumed that a SL UE and its serving gNB (if the UE is in NW coverage) operates with the same radio access technology (RAT) e.g., NR, LTE, and so on. However, all the embodiments apply without loss of meaning to any combination of RATs between the SL UE and its serving gNB.

A SL TX UE is configured with SL carrier aggregation (CA) towards one or multiple (peer) RX UEs, means that the UE is (pre-)configured with multiple SL carriers for its SL transmissions or receptions. Based on this the TX UE can aggregate these SL carriers together for its SL transmissions or receptions. The UE would be able to perform transmissions or receptions according to at least one of the following modes:
The TX UE may only use one of the SL carriers to perform SL transmission or reception at a given time.
The TX UE may use multiple SL carriers of the configured SL carriers simultaneously to perform SL transmission or reception. A transmission or reception on a SL carrier may be fully or partially overlapping in time domain with another transmission or reception on another SL carrier. Also, a transmission or reception on a SL carrier may not be overlapping in time domain with another transmission or reception on another SL carrier.

In addition, the embodiments as described below may be applicable to SL transmission with any cast type including unicast, groupcast and broadcast. In the following embodiments, it is assumed that the gNB, Tx UE and the Rx UE(s) are all SL CA capable and can operate in both licensed and unlicensed spectrum, if not otherwise declared. In addition, it is also assumed that the TX UE and RX UE(s) can be in any coverage scenario:
Under full coverage—Both TX UE and RX UE(s) are within coverage of a gNB
Under partial coverage—Either TX UE or RX UE(s) is within coverage of a gNB
Under no-coverage—Neither the TX UE nor RX UE(s) is within coverage of a gNB Furthermore, the below embodiments are described assuming TX carrier (re-)selection is performed per LCH and/or per carrier. The embodiments are equally applied when TX carrier (re-)selection is performed per SL radio bearer or SL radio flow and/or per carrier.

In any aspect, an embodiment of any one of the TX UE 100, RX UE 200 and the gNB 300 may comprise at least one of the following features or may perform at least one of the following steps.

The overall procedure to enable the setup of the configuredcarriers/configuredunlicensedsubbands set at the TX sidelink UE can be summarized in the following steps:

### Step—1: UE Capability Exchange

Sidelink UEs (TX UE/RX UE) may exchange its radio access capabilities on supported/configured SL band combinations/carrier frequencies via PC5/SL signaling for e.g., UECapabilityEnquirySidelink. This signaling carries at least one of the following information
the supported/configured set of SL carrier frequencies/band combinations
supported SL cast types for each supported/configured SL carrier frequencies/bands
interested services, traffic types or applications and/or L2 IDs mapped to the services, traffic types or applications

This type of radio access capability exchange may be only applicable to unicast communications in some embodiments.

### Detailed Embodiments

In a detailed embodiment, the UE may exchange the above signaling with any neighbor UE over SL, either unsolicited, proactively or based on request from the neighbor UE.

In another detailed embodiment, the UE may forward the received capabilities from a peer UE (on supported/configured SL carrier frequencies) to a gNB, either proactively or based on request from the gNB. In addition, the gNB may signal capabilities of one or multiple TX/RX UEs (on supported/configured SL carrier frequencies/band combinations) to another gNB, other TX/RX UEs under its own coverage, or a core network entity (e.g., AMF, SMF etc).

### Step—2: Setup of Configuredcarriers/Configuredunlicensedsubbands Set (Main Inventive Step)

Upon receiving the Rx UEs' radio access capability information by the TX UE, the higher layers (for e.g., RRC layer) apply a set of configuredcarriers to the LCH associated to the RX UEs such that data arriving at this LCH is be transmitted only on the carriers which are a part of the configuredcarriers set. The configuredcarriers set applied by the higher layers can be based on both TX UE and RX UE capabilities/configurations. For example, the allowed TX carriers for the TX UE or a LCH of the TX UE and supported/configured SL carrier frequencies/bands for RX UE.

### Detailed Embodiments

In a first detailed embodiment, upon receiving the radio access capability information including the supported bands/carriers of a Rx UE, the higher layers (for e.g., RRC layer) of the TX UE applies/configures a set of configuredcarriers that should be used for transmission of data arriving at a LCH associated with the Rx UE based on at least the received radio access capability information of the Rx UE (i.e., the data arriving at this LCH is allowed to be transmitted only over the applied/configured set of configuredcarriersfor the LCH). For each LCH, the application of a set of configuredcarriers can either be done by the TX UE autonomously or upon instructions of a gNB. Upon gNB instruction, the corresponding RX UE capability could be sent to the gNB in a Uu RRC signaling for e.g., as a part of the sidelinkUElnformation (SUI) message. The gNB based on this information can configure the LCH associated with the Rx UE with a set of configuredcarriers for the TX UE.

In a second detailed embodiment, the TX UE may communicate with more than one RX UE (in e.g., a unicast manner). In which case, the TX UE can obtain the RX capability in terms of bands/carriers from those respective RX UE(s). Based on this information, the TX UE can apply a common set of carriers based on all the RX UE capabilities (e.g., capabilities supported by multiple/all the Rx UEs) to form the configuredcarriers set. The selection of the configuredcarriers may be based on a union/intersection and any other similar technique thereof the respective supported RX UE(s) carrier frequencies/band combinations. This would enable the TX UE to communicate with one/more/all the respective RX UE(s) without retuning to different carrier frequencies as this leads to switching delays (i.e., switching among carriers). This is also especially useful in the case that the TX UE has limited hardware capability in terms of the number of radio frequency (RF) chains that it can support.

In a third detailed embodiment, if the TX UE 100 and/or the gNB 300 of the first/second detailed embodiment is unable to perform a complete union/intersection or any other similar technique thereof to find a common set of carriers to form the configuredcarriers set, certain carriers of the set can be prioritized based on the supported services/applications. For e.g., from the set {1,3,4} the carriers {3,4} are selected to form the configuredcarriers set based on the required priority or service. Further, if the union/intersection or any other similar technique thereof results in at least one common carrier across all the RX UE(s), these carriers may be group to form (i.e., to define) a defaultcarriers set. The carriers in the defaultcarriers set are used for procedures related to enabling the TX UE to perform sidelink communications for e.g., synchronization procedures, discovery procedures, direct communication request procedures etc. The defaultcarriers set can be same, overlapped or even different from the configuredcarriers set.

In another aspect of the third detailed embodiment, the TX UE 100 and/or the gNB 300 may apply the configuredcarrier set for a particular destination based on the corresponding traffic requirements and/or services. In an example, in case the Rx UE 200 supports either high frequency band or low frequency band but not both, the Tx UE may configure configuredcarriers depending on the requirement of the highest priority LCH associated to the Rx UE 200, e.g. only include high frequency band in configuredcarriers if the highest priority LCH associated to the Rx UE 200 requires high data rate, while only include low frequency band in configuredcarrier if the highest priority LCH associated to the Rx UE 200 requires high reliability.

In a fourth detailed embodiment, the TX UE 100 and RX UE 200 in any of the above (e.g., detailed) embodiments may operate in an unlicensed spectrum. In this case, the TX UE 100 upon receiving the radio access capability information including the supported bands and/or carrier and/or subbands, applies or configures the one or more LCHs associated with that RX UE 200 with a set of configuredunlicensedsubbands for the data arriving at the LCH(s) in wideband operations. That is, the data arriving at any of those LCH(s) is allowed to be transmitted only over the applied/configured set of configuredunlicensedsubbands.

Alternatively or in addition, the TX UE 100 needs to perform a listen before talk (LBT) procedure (e.g., mandated depending on region, when operating in the unlicensed spectrum) only on those subbands which are included in the sets of configuredunlicensedsubbands applied/configured to all the LCH(s) associated with the Rx UE out of all the subbands configured for unlicensed wideband operation. Like the first detailed embodiment, the application of the LCHs with the configuredunlicensedsubbands can be performed by the TX UE 100 autonomously or with under the instruction of a gNB 300.

In a fifth detailed embodiment, for the case of groupcast or broadcast communications, gNB instruction-based technique can be used to apply a configuredcarriers set for the TX UE. First, each of the RX UE(s) interested in a certain groupcast service can report the L2 ID of the groupcast/broadcast service and its RX (radio access) capability information to the gNB. This would enable the gNB to understand the capabilities of the different RX UE(s) that are interested in receiving the groupcast/broadcast service. The gNB stores the Rx capability associated to the L2 ID, which may be the common capability that are allowed/supported by all the Rx UEs interested in receiving the groupcast/broadcast service. Subsequently, before initiating the groupcast/broadcast transmission, the TX UE can report the L2 ID of the groupcast/broadcast service that it will transmit to the gNB. The gNB based on the received L2 ID from the TX UE can use the stored RX capability information associated to the L2 ID to configure each LCH associated to the L2 ID with a set of configuredcarriers for the TX UE via for example dedicated RRC signaling (i.e., RRCReconfiguration). Alternatively, the gNB can broadcast in the system information (e.g., SIB12) the configuration for each LCH associated to a L2 ID (corresponding to a groupcast/broadcast service) with a set of configuredcarriers based on the stored RX capability information associated to the L2 ID. The Tx UE applies the configuration when transmitting to the L2 ID.

In a sixth detailed embodiment, for the case of groupcast/broadcast communications as described in the fifth detailed embodiment can also be performed without gNB instruction i.e., autonomously by the TX UE. In this case, if the RX UE(s) interested in the groupcast/broadcast service were previously connected to the TX UE in a unicast manner then, the RX UE(s) can exchange the L2 ID(s) which corresponds to the interested groupcast/broadcast service over PC5-RRC signaling. Consequently, when the TX UE wants to transmit a groupcast/broadcast service mapped to the set of L2 ID(s), the TX UE can autonomously apply the LCH associated to the L2 ID(s) with a set of configuredcarriers based on the common capability of the RX UE(s) interested in receiving the groupcast/broadcast service.

In a seventh detailed embodiment, the gNB/TX UE from the fifth and sixth detailed embodiments, like the second detailed embodiment can perform either a union, intersection or any other similar technique thereof to setup the configuredcarriers set.

### Step—3: Carrier Selection

Based on the configuredcarriers set, the TX UE performs selection of the carriers on which transmission is to be performed. Either one or few or all the carriers within the configuredcarriers set can be chosen based on additional criterion like signal strength, measure of congestion etc.

### Step—4: Resource Allocation and Transmission (e.g., LCP Restrictions)

Upon selecting the suitable carriers from the configuredcarriers set, the TX UE selects the corresponding resources for transmission and performs transmission on the selected resources.

### Detailed Embodiments

In an eighth detailed embodiment, based on the configuration/application of the configuredcarriers set for a LCH and the carrier selection procedure where one/many/all the carriers in the configuredcarriers set can be chosen, LCP procedure is applied on the data arriving at this LCH for mapping the data to corresponding resources for transmission. The lower layers report the available resources, carriers for corresponding resources. Then, the LCP procedure at the TX UE in addition to the conditions as described in Section 2.1.4 should also check to see if the available resources are on those carriers (selected in Step—3) which are a part of the configuredcarriers set. In other words, restrictions are applied to this LCH as a part of the LCP procedure, such that the data arriving at this LCH is allowed to be transmitted only over the carriers as configured in the configuredcarriers set. In the case of the TX UE operating in the unlicensed spectrum, the LCP procedure should also check to see if the available resources are on subbands which are a part of the configuredunlicensedsubbands set.

In a ninth detailed embodiment, if the non-availability of the resources in the selected carriers from the configuredcarriers set persists, this can trigger the carrier selection procedure (Step—3) to choose another set of suitable carriers from the configuredcarriers set. The persistence can be quantified, and the carrier selection procedure will be initiated if:
a) A timer can be started as soon as the data has arrived at the LCH and at expiry, the TX UE is unable to transmit the data
b) The TX UE is unable to transmit the data before the packet delay budget (PDB) threshold of the packet.
c) The number of times the TX UE is unable to transmit the data before the PDB of the packet exceeds a particular threshold.
d) If the signal strength on that carrier is below a (pre-)configured or predefined threshold. In this case, signal strength can be measure by RSRP, RSSI or SINR.

In a tenth detailed embodiment, for any of the above (e.g., detailed) embodiments, the signaling alternatives described will include at least one of the below

For signaling between UE and the gNB:
RRC signaling
MAC CE
Paging message
Control PDU of a protocol layer (e.g., SDAP, PDCP, RLC, or an adaptation layer in case of SL relay)
L1 signaling on channels such as PRACH, PUCCH, PDCCH

For signaling between UEs:
RRC signaling (e.g., PC5-RRC)
PC5-S signaling
Discovery signaling
MAC CE
Control PDU of a protocol layer (e.g., SDAP, PDCP, RLC, or an adaptation layer in case of SL relay)
L1 signaling on channels such as PSSCH, PSCCH, or PSFCH.

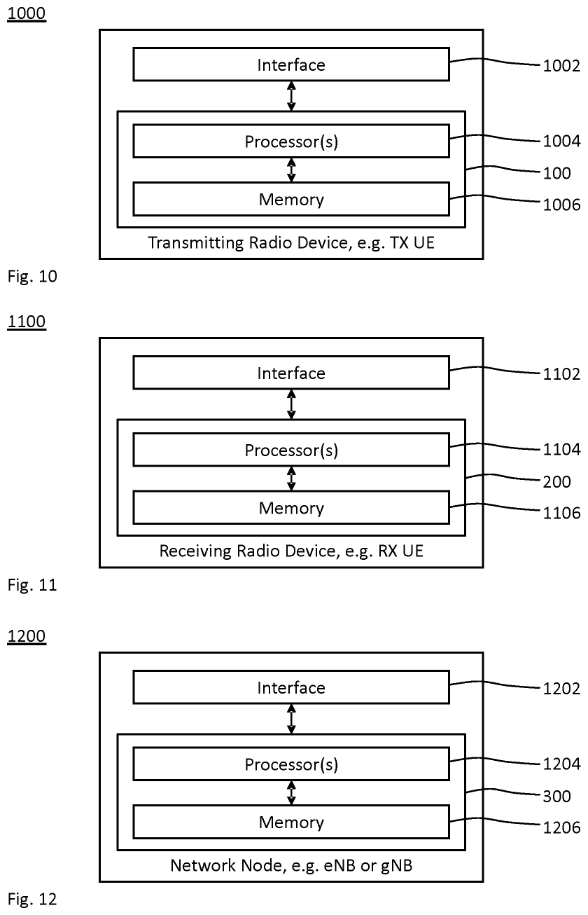

FIG. 10 shows a schematic block diagram for an embodiment of the device 100. The device 100 comprises processing circuitry, e.g., one or more processors 1004 for performing the method 400 and memory 1006 coupled to the processors 1004. For example, the memory 1006 may be encoded with instructions that implement at least one of the modules 102 and 104.

The one or more processors 1004 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1006, transmitter functionality or transmitting radio device functionality. For example, the one or more processors 1004 may execute instructions stored in the memory 1006. Such functionality may include providing various features and steps discussed herein, including any of the benefits disclosed herein. The expression “the device being operative to perform an action” may denote the device 100 being configured to perform the action.

As schematically illustrated in FIG. 10, the device 100 may be embodied by a transmitting radio device 1000, e.g., functioning as a transmitting UE or TX UE. The transmitting radio device 1000 comprises a radio interface 1002 coupled to the device 100 for radio communication with one or more receiving stations, e.g., functioning as the receiving radio device (or a RX UE) and/or the network node.

FIG. 11 shows a schematic block diagram for an embodiment of the device 200. The device 200 comprises processing circuitry, e.g., one or more processors 1104 for performing the method 500 and memory 1106 coupled to the processors 1104. For example, the memory 1106 may be encoded with instructions that implement at least one of the modules 202 and 204.

The one or more processors 1104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1106, receiver functionality or receiving radio device functionality. For example, the one or more processors 1104 may execute instructions stored in the memory 1106. Such functionality may include providing various features and steps discussed herein, including any of the benefits disclosed herein. The expression “the device being operative to perform an action” may denote the device 200 being configured to perform the action.

As schematically illustrated in FIG. 11, the device 200 may be embodied by a receiving radio device 1100, e.g., functioning as a receiving UE or RX UE. The receiving radio device 1100 comprises a radio interface 1102 coupled to the device 200 for radio communication with one or more transmitting or receiving stations, e.g., functioning as a transmitting radio device 100 (TX UE) and/or the network node 300.

FIG. 12 shows a schematic block diagram for an embodiment of the device 300. The device 300 comprises processing circuitry, e.g., one or more processors 1204 for performing the method 600 and memory 1206 coupled to the processors 1204. For example, the memory 1206 may be encoded with instructions that implement at least one of the modules 302 and 304.

The one or more processors 1204 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 300, such as the memory 1206, network node functionality. For example, the one or more processors 1204 may execute instructions stored in the memory 1206. Such functionality may include providing various features and steps discussed herein, including any of the benefits disclosed herein. The expression “the device being operative to perform an action” may denote the device 300 being configured to perform the action.

As schematically illustrated in FIG. 12, the device 200 may be embodied by a network node 1200, e.g., functioning as a base station or a relaying UE or gateway. The network node 1200 comprises a radio interface 1202 coupled to the device 300 for radio communication with one or more other stations, e.g., functioning as the transmitting radio device 100 (TX UE) and/or a receiving radio device 200 (RX UE).

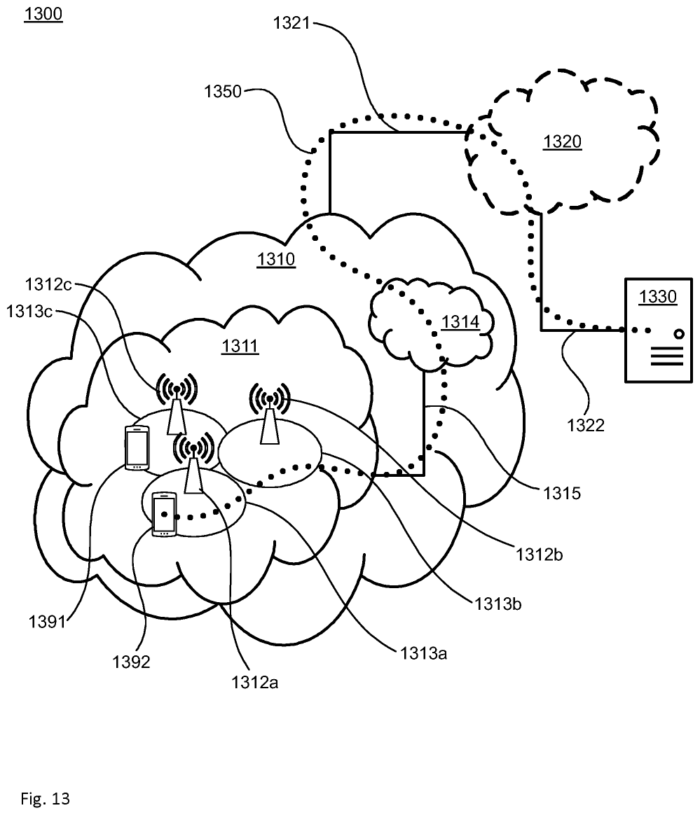

With reference to FIG. 13, in accordance with an embodiment, a communication system 1300 includes a telecommunication network 1310, such as a 3GPP-type cellular network, which comprises an access network 1311, such as a radio access network, and a core network 1314. The access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to the core network 1314 over a wired or wireless connection 1315. A first user equipment (UE) 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Any of the base stations 1312 may embody the network node 300, and/or any of the UEs 1391, 1392 may embody the radio device 100 and/or the radio device 200.

The telecommunication network 1310 is itself connected to a host computer 1330, which may be embodied in the hardware and/or software of a standalone server, a cloud-implemented server, a distributed server or as processing resources in a server farm. The host computer 1330 may be under the ownership or control of a service provider, or may be operated by the service provider or on behalf of the service provider. The connections 1321, 1322 between the telecommunication network 1310 and the host computer 1330 may extend directly from the core network 1314 to the host computer 1330 or may go via an optional intermediate network 1320. The intermediate network 1320 may be one of, or a combination of more than one of, a public, private or hosted network; the intermediate network 1320, if any, may be a backbone network or the Internet; in particular, the intermediate network 1320 may comprise two or more sub-networks (not shown).

The communication system 1300 of FIG. 13 as a whole enables connectivity between one of the connected UEs 1391, 1392 and the host computer 1330. The connectivity may be described as an over-the-top (OTT) connection 1350. The host computer 1330 and the connected UEs 1391, 1392 are configured to communicate data and/or signaling via the OTT connection 1350, using the access network 1311, the core network 1314, any intermediate network 1320 and possible further infrastructure (not shown) as intermediaries. The OTT connection 1350 may be transparent in the sense that the participating communication devices through which the OTT connection 1350 passes are unaware of routing of uplink and downlink communications. For example, a base station 1312 need not be informed about the past routing of an incoming downlink communication with data originating from a host computer 1330 to be forwarded (e.g., handed over) to a connected UE 1391. Similarly, the base station 1312 need not be aware of the future routing of an outgoing uplink communication originating from the UE 1391 towards the host computer 1330.

By virtue of the method 400 and/or 500 being performed by any one of the UEs 1391 or 1392 (as examples of the radio devices 100 and/or 200) and/or the method 600 being performed by any one of the base stations 1312 (as examples of the network node 300), the performance or range of the OTT connection 1350 can be improved, e.g., in terms of increased throughput and/or reduced latency. More specifically, the host computer 1330 may indicate to the RAN 700 or the network node 300 or the transmitting radio device 100 or the receiving radio device 200 (e.g., on an application layer) at least one of a sidelink cast type, a quality of service (QoS), a priority, a service, a traffic type, and an application of the traffic or the data.

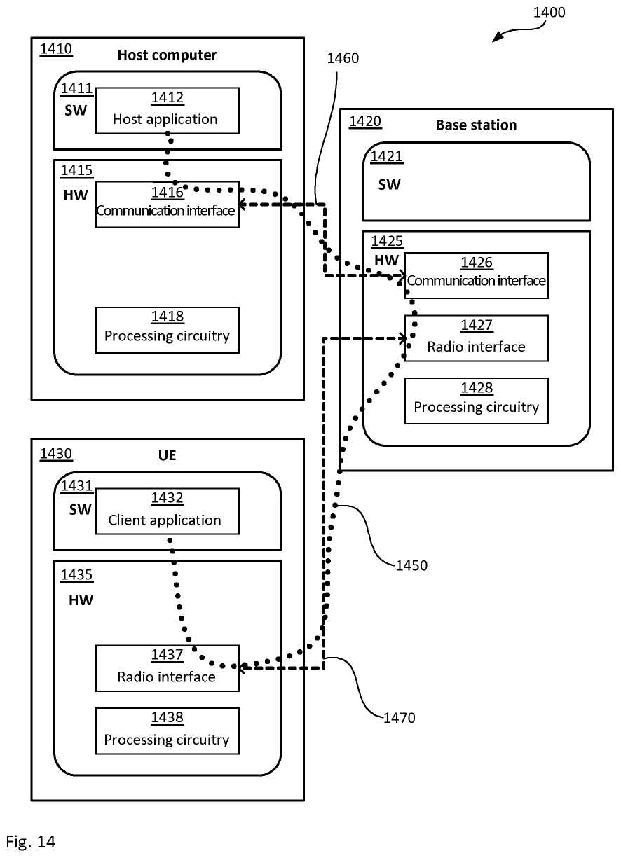

Example implementations, in accordance with an embodiment of the UE, base station and host computer discussed in the preceding paragraphs, will now be described with reference to FIG. 14. In a communication system 1400, a host computer 1410 comprises hardware 1415 including a communication interface 1416 configured to set up and maintain a wired or wireless connection with an interface of a different communication device of the communication system 1400. The host computer 1410 further comprises processing circuitry 1418, which may have storage and/or processing capabilities. In particular, the processing circuitry 1418 may comprise one or more programmable processors, application-specific integrated circuits, field programmable gate arrays or combinations of these (not shown) adapted to execute instructions. The host computer 1410 further comprises software 1411, which is stored in or accessible by the host computer 1410 and executable by the processing circuitry 1418. The software 1411 includes a host application 1412. The host application 1412 may be operable to provide a service to a remote user, such as a UE 1430 connecting via an OTT connection 1450 terminating at the UE 1430 and the host computer 1410. In providing the service to the remote user, the host application 1412 may provide user data, which is transmitted using the OTT connection 1450. The user data may depend on the location of the UE 1430. The user data may comprise auxiliary information or precision advertisements (also: ads) delivered to the UE 1430. The location may be reported by the UE 1430 to the host computer, e.g., using the OTT connection 1450, and/or by the base station 1420, e.g., using a connection 1460.

The communication system 1400 further includes a base station 1420 provided in a telecommunication system and comprising hardware 1425 enabling it to communicate with the host computer 1410 and with the UE 1430. The hardware 1425 may include a communication interface 1426 for setting up and maintaining a wired or wireless connection with an interface of a different communication device of the communication system 1400, as well as a radio interface 1427 for setting up and maintaining at least a wireless connection 1470 with a UE 1430 located in a coverage area (not shown in FIG. 14) served by the base station 1420.

The communication interface 1426 may be configured to facilitate a connection 1460 to the host computer 1410. The connection 1460 may be direct, or it may pass through a core network (not shown in FIG. 14) of the telecommunication system and/or through one or more intermediate networks outside the telecommunication system. In the embodiment shown, the hardware 1425 of the base station 1420 further includes processing circuitry 1428, which may comprise one or more programmable processors, application-specific integrated circuits, field programmable gate arrays or combinations of these (not shown) adapted to execute instructions. The base station 1420 further has software 1421 stored internally or accessible via an external connection.

The communication system 1400 further includes the UE 1430 already referred to. Its hardware 1435 may include a radio interface 1437 configured to set up and maintain a wireless connection 1470 with a base station serving a coverage area in which the UE 1430 is currently located. The hardware 1435 of the UE 1430 further includes processing circuitry 1438, which may comprise one or more programmable processors, application-specific integrated circuits, field programmable gate arrays or combinations of these (not shown) adapted to execute instructions. The UE 1430 further comprises software 1431, which is stored in or accessible by the UE 1430 and executable by the processing circuitry 1438. The software 1431 includes a client application 1432. The client application 1432 may be operable to provide a service to a human or non-human user via the UE 1430, with the support of the host computer 1410. In the host computer 1410, an executing host application 1412 may communicate with the executing client application 1432 via the OTT connection 1450 terminating at the UE 1430 and the host computer 1410. In providing the service to the user, the client application 1432 may receive request data from the host application 1412 and provide user data in response to the request data. The OTT connection 1450 may transfer both the request data and the user data. The client application 1432 may interact with the user to generate the user data that it provides.

It is noted that the host computer 1410, base station 1420 and UE 1430 illustrated in FIG. 14 may be identical to the host computer 1330, one of the base stations 1312a, 1312b, 1312c and one of the UEs 1391, 1392 of FIG. 13, respectively. This is to say, the inner workings of these entities may be as shown in FIG. 14, and, independently, the surrounding network topology may be that of FIG. 13.

In FIG. 14, the OTT connection 1450 has been drawn abstractly to illustrate the communication between the host computer 1410 and the UE 1430 via the base station 1420, without explicit reference to any intermediary devices and the precise routing of messages via these devices. Network infrastructure may determine the routing, which it may be configured to hide from the UE 1430 or from the service provider operating the host computer 1410, or both. While the OTT connection 1450 is active, the network infrastructure may further take decisions by which it dynamically changes the routing (e.g., on the basis of load balancing consideration or reconfiguration of the network).

The wireless connection 1470 between the UE 1430 and the base station 1420 is in accordance with the teachings of the embodiments described throughout this disclosure. One or more of the various embodiments improve the performance of OTT services provided to the UE 1430 using the OTT connection 1450, in which the wireless connection 1470 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1450 between the host computer 1410 and UE 1430, in response to variations in the measurement results. The measurement procedure and/or the network functionality for reconfiguring the OTT connection 1450 may be implemented in the software 1411 of the host computer 1410 or in the software 1431 of the UE 1430, or both. In embodiments, sensors (not shown) may be deployed in or in association with communication devices through which the OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of the OTT connection 1450 may include message format, retransmission settings, preferred routing etc.; the reconfiguring need not affect the base station 1420, and it may be unknown or imperceptible to the base station 1420. Such procedures and functionalities may be known and practiced in the art. In certain embodiments, measurements may involve proprietary UE signaling facilitating the host computer's 1410 measurements of throughput, propagation times, latency and the like. The measurements may be implemented in that the software 1411, 1431 causes messages to be transmitted, in particular empty or “dummy” messages, using the OTT connection 1450 while it monitors propagation times, errors etc.

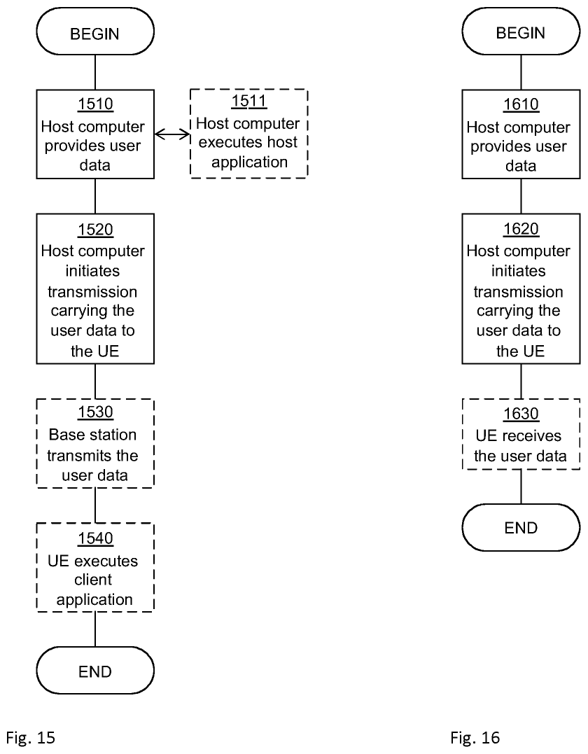

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this paragraph. In a first step 1510 of the method, the host computer provides user data. In an optional substep 1511 of the first step 1510, the host computer provides the user data by executing a host application. In a second step 1520, the host computer initiates a transmission carrying the user data to the UE. In an optional third step 1530, the base station transmits to the UE the user data which was carried in the transmission that the host computer initiated, in accordance with the teachings of the embodiments described throughout this disclosure. In an optional fourth step 1540, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this paragraph. In a first step 1610 of the method, the host computer provides user data. In an optional substep (not shown) the host computer provides the user data by executing a host application. In a second step 1620, the host computer initiates a transmission carrying the user data to the UE. The transmission may pass via the base station, in accordance with the teachings of the embodiments described throughout this disclosure. In an optional third step 1630, the UE receives the user data carried in the transmission.

As has become apparent from above description, at least some embodiments of the technique enable the transmitting radio device (TX UE) to communicate with the receiving radio device (RX UE) using only frequency resources (out of the configured frequency resources) supported by the RX UE, e.g., bands or carriers or subbands supported by the RX UE.

Same or further embodiments enable the TX UE to perform carrier selection (among the configured set, e.g. for carrier aggregation) based on the common band and/or carrier capabilities among different RX UEs (e.g., each configured for sidelink communication). For example, the TX UE may use one or more common carriers supported by more than one RX UE. This could result in lesser switching time among the carriers and can improve power efficiency or spectral efficiency.

Same or further embodiments ensure that the TX UE and the one or more RX UEs can perform procedures to enable sidelink communications (e.g. synchronization procedure and/or discovery procedure etc.), for example based on a configuration message received from a network node.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1.-53. (canceled)

54. A method performed by a transmitting radio device for transmitting data to a receiving radio device, the method comprising:
receiving a radio access capability message indicative of a set of carriers supported by the receiving radio device;
providing a set of configured carriers based on the set carriers indicated in the radio access capability message; and
transmitting data to the receiving radio device using at least one carrier from a set of configured carriers;
further comprising applying the set of configured carriers to a logical channel prioritization, LCP, procedure at the transmitting radio device such that the data arriving at this logical channel, LCH, is allowed to be transmitted only over carriers of the set of carriers.

55. The method of claim 54, wherein the configured carriers result from restricting carriers supported by the transmitting radio device to carriers indicated in the radio access capability message.

56. The method of claim 54, wherein the radio access capability message is received from the receiving radio device, in response to a discovery message transmitted from the transmitting radio device.

57. The method of claim 54, wherein the radio access capability message is received from a network node serving at least one of the transmitting radio device or the receiving radio device.

58. The method of claim 54, wherein the transmitting of the data uses carrier aggregation, and wherein the carriers comprise component carriers for the carrier aggregation.

59. The method of claim 54, further comprising:
reporting a layer 2 identifier, L2 ID, of the planned transmission and/or the received radio access capability message to a network node serving the transmitting radio device; and
receiving the configuration message from the network node, the configuration message being indicative of the set of carriers configured based on the received radio access capability message.

60. The method of claim 54, wherein the radio access capability message, or each of the radio access capability messages, is further indicative of at least one of:
a sidelink cast type;
a quality of service, QoS;
a priority;
a service;
a traffic type; and
an application,
for each of the carriers supported by the receiving radio device.

61. The method of claim 60, wherein the set of configured carriers is selected based on at least one of the sidelink cast type, the quality of service, the priority, the service, the traffic type, and the application indicated in the received radio access capability message, optionally if there is no overlap between the received set of carriers supported by the receiving radio device and a set of carriers supported by the transmitting radio device and/or if there is no overlap between all the received sets of carriers supported by the multiple receiving radio devices.

62. The method of claim 54, wherein the overlap between the received set of carriers supported by the receiving radio device and the set of carriers supported by the transmitting radio device and/or the overlap between all the received sets of carriers supported by the multiple receiving radio devices defines a default set of carriers,
wherein the transmitting radio device uses the default set of carriers for at least one of: initiating or maintaining a sidelink between the transmitting radio device and the receiving radio device synchronization with the receiving radio device, synchronization with all the receiving radio devices, transmitting a discovery message to the receiving radio device, transmitting a discovery message to all the receiving radio devices, receiving a discovery message from the receiving radio device, and receiving a discovery message from each of the receiving radio devices.

63. The method of claim 54, wherein the transmitting radio device and the receiving radio device operate in a shared radio spectrum and wherein the sidelink between the transmitting radio device and the receiving radio device uses a or the shared radio spectrum.

64. The method of claim 54, wherein the set of configured carriers is or comprises a set of configured unlicensed subbands in a or the shared radio spectrum, and
wherein a logical channel, LCH, associated with the receiving radio device is mapped to a set of configured unlicensed subbands for transmitting the data arriving at the LCH in wideband operations.

65. The method of claim 54, wherein at least one frequency resource of the set of carriers configured based on the received radio access capability message is selected by the transmitting radio device, depending on at least one of:
a signal strength measured at the transmitting radio device for the receiving radio device; and
a congestion level measured at the transmitting radio device.

66. The method of claim 54, wherein the at least one frequency resource is selected or reselected by the transmitting radio device from the set of carriers configured based on the received radio access capability message if a previously selected frequency resource is persistently not available due to one of the following situations:
a timer expires that was started upon arrival of the data to be transmitted at the LCH;
the transmitting radio device is unable to transmit the data before a threshold of a packet delay budget, PDB, associated to the data;
a number of times the transmitting radio device is unable to transmit the data before the threshold of the PDB associated to the data exceeds a predefined maximum;
a signal strength measured on the previously selected frequency resource is less than a predefined minimum.

67. The method of claim 54, wherein the radio access capability message is received from the receiving radio device at the transmitting radio device using at least one of:
radio resource control, RRC, signaling, sidelink RRC signaling or PC5 RRC signaling;
PC5-S signaling;
a discovery message;
a medium access control, MAC, control element, CE;
a control protocol data unit, PDU, of a protocol layer;
a PDU of a service data adaptation protocol, SDAP, layer;
a PDU of a packet data convergence protocol, PDCP, layer;
a PDU of a radio link control, RLC, layer;
a PDU of an adaptation layer for a sidelink relay;
physical layer signaling;
sidelink control information, SCI;
signaling on a physical sidelink control channel, PSCCH;
signaling on a physical sidelink feedback channel, PSFCH;
signaling on a physical sidelink shared channel, PSSCH.

68. A transmitting radio device for transmitting data to a receiving radio device, the transmitting radio device comprising memory operable to store instructions and processing circuitry operable to execute the instructions, such that the radio device is operable to:
receive a radio access capability message indicative of a set of carriers supported by the receiving radio device; and
providing a set of configured carriers based on the set carriers indicated in the radio access capability message; and
transmit data to the receiving radio device using at least one frequency resource from the set of configured carriers;
further being operable to applying the set of configured carriers to a logical channel prioritization, LCP, procedure such that the data arriving at this logical channel, LCH, is allowed to be transmitted only over carriers of the set of carriers.

69. A network node for configuring a transmitting radio device, the network node comprising memory operable to store instructions and processing circuitry operable to execute the instructions, such that the network node is operable to:
receive a radio access capability message, the radio access capability message being indicative of a set of carriers supported by a receiving radio device; and
transmit the radio access capability message to the transmitting radio device, the configuration message being indicative of a set of configured carriers based on the received radio access capability message, wherein the configuration message configures the transmitting radio device for transmitting data to the receiving radio device using at least one frequency resource from a set of configured carriers.
